(19) United States
(12) Patent Application Publication
(10) Pub. No.: US 2008/0172381 A1
(43) Pub. Date: Jul. 17, 2008

(54) METHOD AND SYSTEM FOR CONNECTING SERVICE PROVIDERS WITH SERVICE REQUESTORS

(76) Inventor: Paul SUH, New York, NY (US)

Correspondence Address: KING & SPALDING, 1185 AVENUE OF THE AMERICAS, NEW YORK, NY, 10036-4003, US

(21) Appl. No.: 12/015,887

(22) Filed: Jan. 17, 2008

Related U.S. Application Data
(60) Provisional application No. 60/885,395, filed on Jan. 17, 2007.

(51) Int. Cl. G06F 7/10; G06F 17/30; G06F 7/50; G06Q 30/00

(52) U.S. Cl. 707/5; 708/670; 705/14; 707/E17.014

(57) ABSTRACT

A system and method for connecting service providers with service requesters within a social network. The system and method may operate even if the service requestor does not provide any compensation and is not subject to any obligation in return for the service provided by the at least one service provider. The system and method may be based on user feedback and/or a point system. The system and method may be applied to a social network for connecting pet owners with pet sitters for provision of pet-sitting services.

### FIELD OF THE INVENTION

This invention relates to computer-implemented social networking. More specifically, this invention relates to systems and methods for connecting service providers with service requestors within a social network.

### BACKGROUND

Society has developed mechanisms for providing and receiving many kinds of services. However some particular types of services are still difficult to find. For example, a pet owner who leaves town has a limited number of options for caring for his pet in his absence. The options include, for example, (i) boarding or kenneling the pet; (ii) leaving the pet with a family member or friend; and (iii) leaving the animal alone in the house if the length of the stay away from the home is anticipated to be short. Each option has its disadvantages. Boarding a pet exposes the animal to stress and infectious diseases as well as representing a significant expense to the owner. Moreover, not all pets have commercial boarding options. A dog or cat owner can readily board their pet. The owners of less common pets, such as birds or lizards, typically have no such option. Leaving the pet with a family member or friend works only when the family member and/or friend is available and so long as the owner is not leaving town frequently. Moreover, relying on family members and friends runs the risk of abusing personal relationships.

Other options are even less desirable. Many feel that leaving an animal at home alone and unattended is morally wrong and could be potentially harmful to the animal. For instance, if the owner leaves with an expectation of being gone two days and one night may find it difficult if not impossible to return home in that time if flights are cancelled due to inclement weather or other emergency. Additionally, something may happen to the pet's home such as HVAC failure or other mechanical failure that would jeopardize the pet's life.

Some individuals may experience an opposite problem, namely, the need to care for a pet for short periods of time. For example, some individuals might want to explore pet ownership without the long term commitment that full ownership entails.

Similar, unsolved problems exist in other fields relating to services such as house sitting, personal training, etc.

### SUMMARY OF THE INVENTION

In a first aspect, the invention provides a system for connecting service providers with service requesters. The system may comprise a database storing user profiles for a plurality of users, the users comprising service providers and service requesters, a requesting tool receiving a service request from a service requestor, the service request including service information, a query tool receiving query options from the service requestor, generating a list of service providers based on the query options, and sending the list of service providers to the service requestor, a selection tool receiving from the service requester a selection message identifying at least one service provider, and a feedback tool receiving from the service requestor a service requester feedback message relating to a service provided by the at least one service provider, and storing the service requestor feedback message in the user profile of the service provider. The query tool may generate the list of service providers based on the service information. The feedback tool may receive from the at least one service provider a service provider feedback message relating to the service provided by the at least one service provider, and store the service provider feedback message in the user profile of the service requester. The user profile may include a user's location and rating, and the search tool may generate the list of service providers based on at least one of physical proximity, services requested, provider rating, and requester rating. The list of service providers may comprise only service providers with which the service requestor has directly communicated regarding the service request. The system may limit communication between a service requester and service providers based on whether a service request has been received from the service requester. In an embodiment, the service requestor does not provide any compensation and is not subject to any obligation in return for the service provided by the at least one service provider. The system may further comprise a promotional tool sending the service requestor promotional information based on the service information. In an embodiment, the service requestor is a pet owner, the at least one service provider is a pet sitter, and the service is pet sitting. The system may also include a journal tool receiving journal entries from the service provider regarding a service that the service provider is performing and sending the journal entries to the service requester. In an embodiment, the system may further comprise a rating tool computing a user rating based on the service provider feedback message and the service requestor feedback message.

In another aspect, the invention provides a method for connecting service providers with service requesters. The method may comprise receiving a service request from a service requestor, the service request including service information, receiving a service request from a service requester, the service request including service information, receiving query options from the service requester, generating a list of service providers based on the query options, sending the list of service providers to the service requester, receiving from the service requester a selection message identifying at least one service provider, receiving from the service requester a service requestor feedback message relating to a service provided by the at least one service provider, and storing data associating the service requester feedback message with the service provider.

In a further aspect, the invention provides a method for providing and soliciting services in a computer-based social network, where the social network includes a plurality of users. The method may comprise adding points to a user for services performed by said user for other users of the social network, subtracting points from a user for services received by said user from other users of the social network, and limiting a user's ability to receive services from other users of the social network unless said user's points exceed a threshold. The method may further include the steps of matching a user providing services to a user receiving services, and adding points to, and subtracting points from, the user providing services and the user receiving services only after the users have been matched. The method may also further include the step of sending promotional information to a user based on services requested by said user. In an embodiment, the method includes the step of assigning points to a user for one of accessing a website, entering information into a database, and requesting services from other users of the social network. The method may also include the step of assigning points to a user based on a money payment by said user.

### BRIEF DESCRIPTION OF THE DRAWINGS

Embodiments of the invention will now be described with reference to the appended drawings in which:

FIG. 1 shows a flow chart describing an exemplary registration process to become a member of a Unilateral Barter Community in an embodiment of the invention.

FIG. 2 shows a flowchart describing the system checks that occur when a user logs into the Unilateral Barter Community website in an embodiment of the invention.

FIG. 3 shows a flowchart of the different statuses that a Job goes through from beginning to end within the system in an embodiment of the invention.

FIG. 4 shows a flowchart illustrating the system processes that occur when a Service Requestor creates or edits a job in an embodiment of the invention.

FIG. 5A shows a flowchart illustrating the system process for searching the Unilateral Barter Community for either a Service Provider or a Job associated with a Service Requestor in an embodiment of the invention.

FIG. 5B shows an exemplary screen shot of a message from a Service Requestor to a Service Provider in an embodiment of the invention.

FIG. 6A describes the system process for assigning a Job to a Service Provider in an embodiment of the invention.

FIG. 6B shows an exemplary screen shot of a drop down box in an embodiment of the invention.

FIG. 7 illustrates the system flowchart for the Journal Tool in an embodiment of the invention.

FIG. 8A illustrates the system flowchart for the Feedback Tool in an embodiment of the invention.

FIG. 8B shows an exemplary screen shot of a web form relating to the Feedback Tool.

FIG. 9A illustrates another embodiment of the system, implementing a points program.

FIG. 9B and FIG. 9C illustrates some detailed examples of the point system in an embodiment of the invention.

FIG. 10 illustrates the site architecture and navigation site map in an embodiment of the invention.

FIG. 11 illustrates a set of database fields within the my profile database for each individual user of the site in an embodiment of the invention.

FIG. 12 illustrates a set of relational database entity flowchart and relationships between fields in an embodiment of the invention.

Corresponding elements in different drawings are indicated by the same numerals.

### DETAILED DESCRIPTION

The invention will now be described with reference to specific embodiments. In the following description, the phrase “Unilateral Barter” relates to the provision of services by an individual or group of individuals (“Service Provider”) for another individual or group of individuals (“Service Requestor”) and in which no compensation is necessarily provided, or future obligation created, between the parties to the transaction. Accordingly, a “Unilateral Barter Community” relates to a community, network, or similar organization of individuals where each Service Provider may perform a service for a Service Requestor without the necessary expectation of receiving compensation or creating a future obligation for the service. In Unilateral Barter Communities it is expected that individuals in the community will perform services as Service Providers for other members or Service Requestors based at least in part on the expectation that on a further date, the Service Provider can change roles and become the Service Requestor and receive a service without paying compensation and/or assuming an obligation. In this sense the Unilateral Barter Community is a reserve of good will that any member of the community can draw from without necessarily obligating individual members specifically to each other.

A specific embodiment of the invention referred to as the “Unilateral Barter Community Tools” will now be described with reference to a system for exchanging pet sitting services. It will be appreciated, however, that the invention is also applicable to other services, personal or otherwise, such as pet boarding, house sitting, personal training services, etc. Also, an embodiment of the invention will be described as implemented in a Web site, however other implementations are possible.

The Unilateral Barter Community Tools operate generally to allow the users in the Unilateral Barter Community to use specific online tools to aid in, for example:

1) locating, evaluating and selecting another member of the Unilateral Barter Community;

2) achieving task #1 without necessarily revealing private user profile information such as personal address and email address;

3) initiating ongoing contact with said member of the Unilateral Barter Community and request that said member act either as Service Provider or Service Requestor in the near future;

4) assigning said pet sitting service upon the acceptance of the Service Provider;

5) maintaining communications between the Service Provider and Service Requestor throughout the days of the service;

6) evaluating said service by providing feedback and commentary about the services of the Service Provider and posting it to the user's profile; and

7) evaluating said Service Requestor by providing feedback and commentary about the nature of the Service Requestors pet and/or home and posting it to the user's profile.

Information about existing users of the site may be stored in a user database, comprising for example names, addresses, email addresses, telephone numbers, usernames and passwords. This information is referred to as a “Basic User Profile.”

In order to facilitate locating, evaluating, and selecting another member of the Unilateral Barter Community, an embodiment of the invention may include a three-step user registration process, referred to herein as the “Enhanced User Profile.” In a first step, the Basic User Profile may contain common user profile data such as, name, address, city, state, zip code, telephone, email, username and password. In a preferred embodiment, the system may not publicly reveal the address data and email data to other members of the Unilateral Barter Community, but it may utilize the address fields in the search process to create searches and list user search results ordered by proximity to the user who initiated the system search.

In a second step, the Enhanced User Profile may append to the user profile database several additional, relevant data fields to the Basic User Profile using two additional steps to the user registration process: pet details and services details. The system may publicly display all the data fields within pet details including specific information about the species of pet, age, bio, temperament, activity levels and socialization. These are all details that a Service Provider in the Unilateral Barter Community may look at in order to evaluate whether providing a service for this pet would fit within his own personal lifestyle and requirements. For example, a situation where a Service Requestor's dog is indoor potty trained, may not be suitable for a Service Requestor who just spent months training his dog to be outdoor potty trained. In this case, the Service Provider may review the activity level field of the pet details and evaluate whether or not it would be a good fit to accept a Service Requestors request for pet sitting.

In a third step of the registration process, relating to service details, the system may capture and store data regarding the kinds of services the member may be willing to provide as a Service Provider. For example, members may choose the location in which they provide the service. For example, this may simply be a choice of two locations: on-site or boarding. On-site herein referred to as “On-site” refers to providing a pet sitting service at the location of where the Service Requestor resides. Boarding herein referred to as “Boarding” refers to providing the service at the location where the Service Provider resides. For members who already have pets of their own, it may be impractical to choose on-site because it would require the Service Provider to leave his own pets behind to fulfill the service. Additional service details may include attributes like walking, feeding, indoor exercise/playtime and transportation. As with the pet details, the system may publicly display all service details to aid in the evaluation process as other members peruse the Enhanced User Profile.

The next tool in this embodiment of the Unilateral Barter Community Tools, referred to herein as “Jobs,” involves the system capturing new user inputted data from a web form to be stored into user database. Jobs may be specifically created when a user of the Unilateral Barter Community wants to become a Service Requestor in the future. Data fields that are stored may include: job title, destination, start date of service requested, end date of service requested, location of requested services and what services are being requested. The system may track and store all jobs that get created regardless of whether or not those jobs get filled in the future. Maintaining this log of prior user jobs may allow the system to be accessed in the future for purposes of displaying highly targeted consumer offerings, advertisements or promotions.

In a preferred embodiment, the system may not allow Users of the Unilateral Barter Community to contact each other unless a Job is already in a user's queue. However in other embodiments, it may not be mandatory to first have a job in the user queue to initiate contact with another user. Once the user has a job in the queue, the system may recognize the user as the Service Requestor and may allow said user to begin messaging other members of the Unilateral Barter Community using its proprietary messaging system. The system may automatically pass details about the Service Requestor's job to the message recipient in the form of a web hyperlink that the Service Provider may click to see the full detail of what service needs to be provided.

The next tool in this embodiment of the Unilateral Barter Community Tools involves the assignment of a job. Once a Service Requestor has successfully communicated back and forth with a Service Provider, the assignment tool may automatically create a drop down list of all the usernames with which the Service Requestor has had back and forth communications. When the Service Requestor has chosen a willing Service Provider, he may select the Service Provider's username and the system automatically sends the Service Provider an email requesting confirmation of the assignment of the Job to the Service Requestor. Upon successful confirmation, the assignment tool may automatically send the Service Requestor an email informing him or her of the acceptance.

The next tool in this embodiment of the Unilateral Barter Community Tools, referred to herein as the Journal Tool, may allow the system to facilitate communications between the Service Provider and the Service Requestor throughout the duration of the Job. The Journal Tool may check the current date and compare it to the dates of the assigned job, and may automatically send daily reminders to the Service Provider to log in to the website and post a journal entry describing the day's services to the Service Requestor. Upon successful completion of the journal entry, the Journal Tool may automatically send an email alert to the Service Requestor with a link to log in and view the Service Provider's entry.

The next tool in this embodiment of the Unilateral Barter Community Tools, referred to herein as the Feedback Tool, may provide a mechanism for both the Service Provider and the Service Requestor to build on their Enhanced User Profile and add feedback to their publicly displayed feedback ratings. The system may store and display a user's feedback rating in 3 sections. In the first section, the system may calculate a numerical average based on a grading scale of 1 to 5 (5 being the best) on 4 different categories of service. It may then average all the ratings surveys together and display the average score. In the second section, the system may count and display how many feedback surveys have been completed about the user. In the third section, the system may store and display a compilation of all the written user feedback regarding another user. Upon the completion of a Unilateral Barter transaction, the system may automatically send an email to both the Service Provider and the Service Requestor and provide a link for each user to complete a feedback survey.

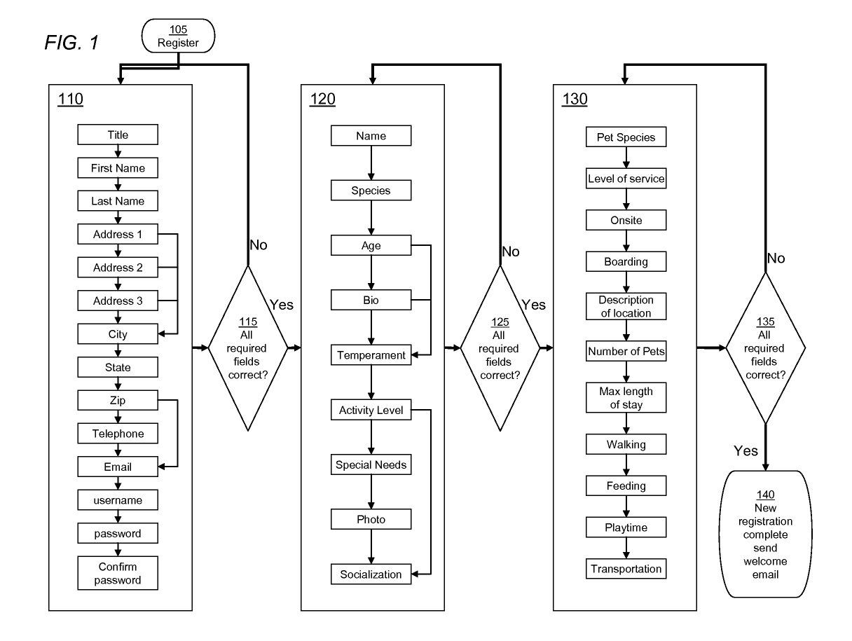

A further embodiment of the invention will now be described with reference to the appended figures. FIG. 1 shows a flow chart describing an exemplary registration process to become a member of a Unilateral Barter Community in an embodiment of the invention. The registration process begins at step 105. At step 110 a user may enter a set of personal data including title, first name last name, address1, address2, address3, city, state, zip, telephone, email, username, password and confirm password. In a preferred embodiment, the system may require all fields to be mandatory except for address2, address3 and telephone. At step 115, the system may check to see if the data inputted to the two password fields match and all required fields are filled in before it allows the user to move onto step 120. If there is a mistake, the system may return the user to step 110 and highlight the problematic field in red along with an error message briefly describing the error.

At step 120, the user may enter some set of pet data, including: name, species, ages, bio, temperament, activity level, special needs, photo and socialization. In a preferred embodiment, the age, bio, special needs and photo fields may be optional. Similarly to step 115, the system may check at step 125 to see if all mandatory fields are populated and may not allow the user to advance to step 130 of the registration process until all mandatory fields are filled in. Incorrect data may bring the user back to step 120 and highlight the problematic field in red along with an error message briefly describing the error.

At step 130, the user may input some set of data relating to services, including for example pet species (i.e., the species of pets the user is willing to provide sitting services for), level of service (e.g., a choice of professional, non-professional and barter), location of service (e.g., on-site or boarding), description of location, number of pets, max length of stay, walking, feeding, playtime and transportation. This registration step by comparison to the first two steps 110 and 120, may be more complex because the system dynamically generates more or less fields depending on what the user has selected in prior fields. For example, if the user has informed the system that he or she is a professional sitter, the system may generate new data fields asking for both insurance and bonding information relating to his or her professional pet sitting practice. In addition, the system may also generate new data fields for rates to be filled in for each of the services that the user is willing to provide. Similarly, if the user informs the system that he or she is a non-professional sitter, new fields may be generated where the user may be asked for the rates in which he is willing to provide the services. If the user has selected “boarding” in the location section, the system may create a new field where the user is asked to provide a brief description of the Service Providers' home or location where he may be providing future services. Once again, the system may check at step 135 to see if all the appropriate fields have data inputted where it is required before allowing the user to complete the registration. Once registration is complete at step 140, the system may send an automated email alert to the provided email address to confirm the registration.

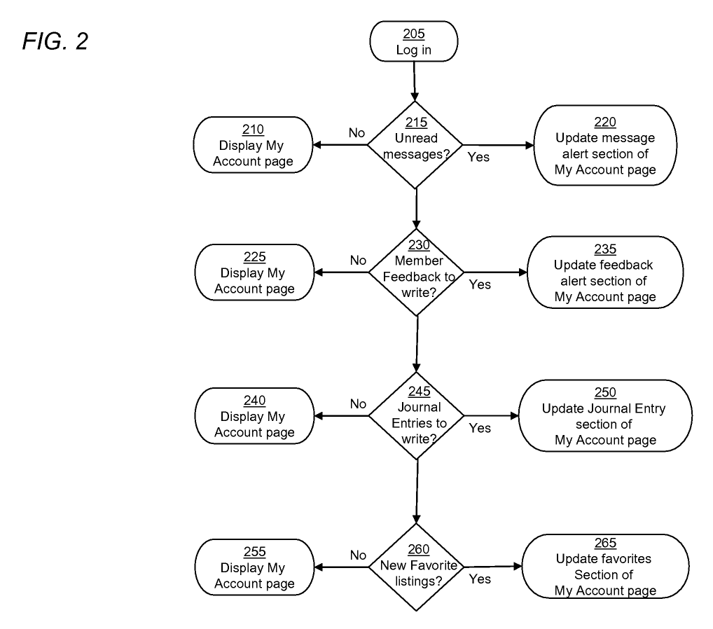

FIG. 2 shows a flowchart describing the system checks that occur when a user logs into the Unilateral Barter Community website in an embodiment of the invention. The process begins at step 205. The user's welcome page has, for example, four stages in which the system checks for updates upon each login. First, at step 215, the system may check the member's inbox to see whether he or she has any new messages. If there are new messages, the system may updated the members message section at step 220, or continue on to step 210 if there are not any new messages. Second, at step 230, the system may check whether the member has completed any jobs recently and if they user has any feedback to submit. Third, at step 245, the system may check whether the user is currently participating in any jobs and has any journal entries to complete. At step 260, the system may check whether anyone in the network has listed this member as a favorite. Upon making all these checks, the system may update the member's welcome page in steps 220, 235, 250 and 265 and inform the member of how many new items there are for him or her to review. For example, the system may inform the user that there are 2 new messages and 1 new journal entry to write. Alternatively, upon making all these checks, if the system does not find any new items to update, it will display all sections without updates as in steps 210, 225, 240 and 255.

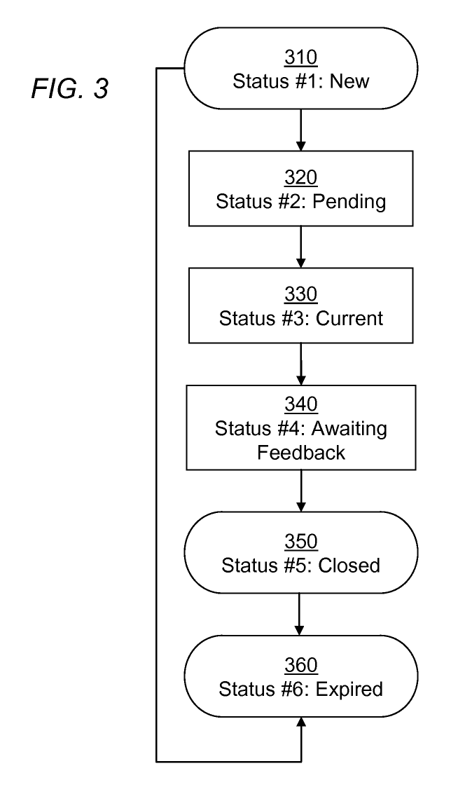

FIG. 3 shows a flowchart of the different statuses that a Job goes through from beginning to end within the system in an embodiment of the invention. These statuses may be useful in an exemplary implementation of the system because they are the trigger points which the system uses to send different email alerts out to the users with various links to return to the site.

Once a Service Requestor fills in a new Job web form, the system may for example create the job, store it in the user database and post the job for public or private viewing. At step 310, The system may initialize the job's status as “new.” The job may remain in this status until the system assigns the job to a Service Provider or expires (step 360). The system may label a job as expired if the end date passes without the job having been assigned to a Service Provider. However, the system may store all jobs regardless of whether or not they have been assigned. In an alternative embodiment, the system may “mine” all the stored job data within a user profile, and display highly targeted travel information, offerings, promotions, advertisements or combinations thereof.

For example, as long as a Service Requestor has a future Job stored in the user profile, the system may allow the Service Requestor to contact all members of the Unilateral Barter Community about potentially becoming their sitter.

During a “discovery” period, the system may facilitate the sending of messages back and forth from the Service Requestor with potential Service Providers. If the potential Service Provider responds to a message of the Service Requestor, the system may automatically add the Service Provider usernames to a drop down list of Service Providers that the Service Requestor may assign the job to. In a preferred embodiment, the system may not allow the Service Requestor to assign the job to a member he has not been in contact with. When the Service Requestor selects a username from the dropdown list, the system may send an automated email to the selected Service Provider requesting a confirmation of the job assignment. When the Service Provider hits the button to confirm the request, the system may automatically send an acceptance notification to the Service Requestor and changes the job status to “pending” and thereby completing step 320.

At step 330 the system may change the job status to “current” on the first day of the job. Then, the system may send an automated email alert to the Service Provider reminding him or her that it is the first day of the job and to log in and complete a journal entry summarizing the day's activities with the pet. This entry may for example be shared with the Service Requestor. Upon completion of each journal entry, the system may send an automated email to the Service Requestor informing him or her of the updated journal entry, and providing a link to review the entry. The system may preferably continue to send these reminders every day during the job. If the Service Provider fails to update the journal entry, the system may for example send an email alert to the Service Requestor informing him or her of the failure of the Service Provider to update the daily journal.

At step 340, the system may change the job status to “awaiting feedback” one day after the last day of the job. The system preferably sends an email alert to both Service Provider and Service Requestor to fill out a brief feedback survey form about their experience with each other. Upon successful completion of a feedback survey form the system may send an automated alert to the recipient of the survey and update that user's ratings profile.

At step 350, The system may preferably change the job status to “closed” once both feedback forms are completed or 30 days have passed, whichever happens first.

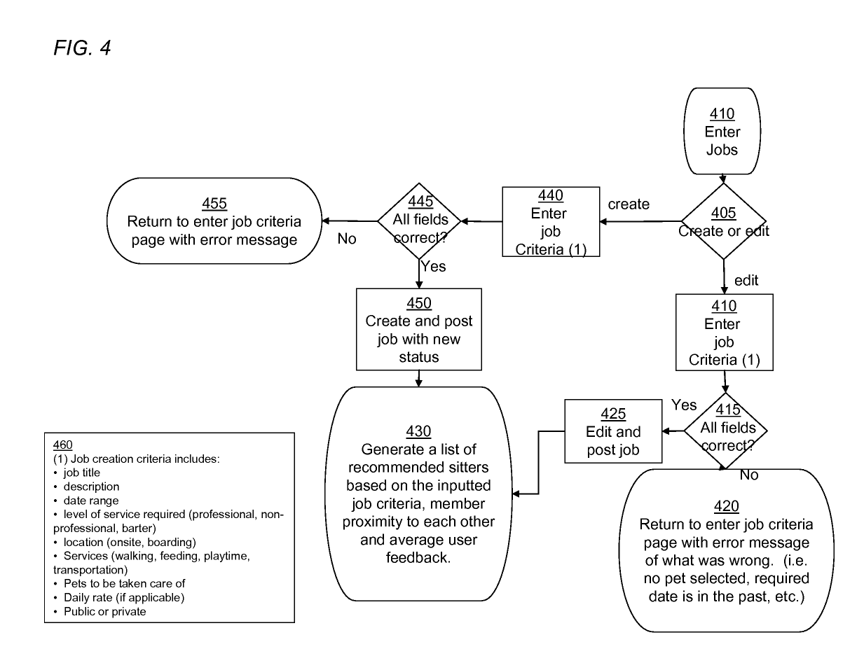

FIG. 4 shows a flowchart illustrating the system processes that occur when a Service Requestor at steps 405 and 410, creates or edits a job in an embodiment of the invention. The job criteria that users fill in at steps 410 and 440 include for example: job title, description, start date, end date, level of service required, location, services, pets, daily rate if applicable, and public or private. Similar to the registration process, at steps 415 and 445, the system preferably checks if the user populated all the necessary data fields, and returns him or her to the edit or create new job page if there are any errors at steps 420 and 455, along with a brief description of what the problem is. As shown in footnote (1) in FIG. 4 (block 460), the job title may be for example a simple summary used to describe a job, such as: “January business trip to Boston”, or “I'm going to Disneyland.” Description may be a more detailed description about what sort of sitting service will be required. Start date and end dates may refer to the first day and last day that the Service Requestor will require sitting services. Level of service required may refer to whether the member is seeking professional sitters, non-professional sitters or free barter members. Location may refer to the location in which the Service Requestor would like the service to occur. Services may refer to what services the member is seeking and they could include: walking, feeding, playtime/indoor exercise, or transportation. Pets to be taken care of may refer to which pets require the services. Daily rate may refer only to the situation where the member selects professional or non-professional as the desired level of service. If applicable, the member may enter what daily rate he or she is willing to pay for the services. Public or private is an option the Service Requestor can choose if he or she wants his job to appear publicly within the system's search results or remain hidden. Other fields may be added according to user requirements.

Once the user completes all the job criteria fields successfully, the system may post the job with a “new” status at steps 425 and 450. Then at step 430, the system may examine the job criteria and analyze which members of the Unilateral Barter Community would be a good fit for the job. To this purpose the system may utilize the job criteria, proximity and average user feedback rating. The system may then generate a list of potentially qualified Service Providers.

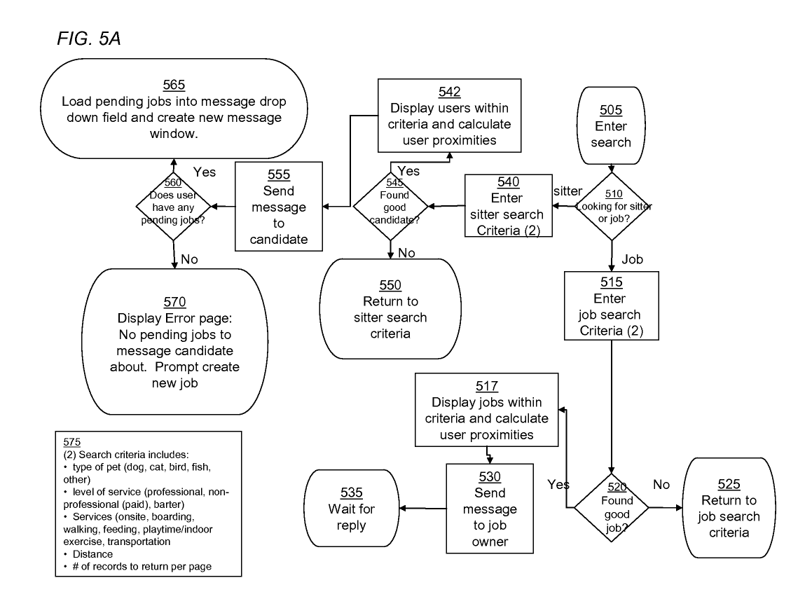

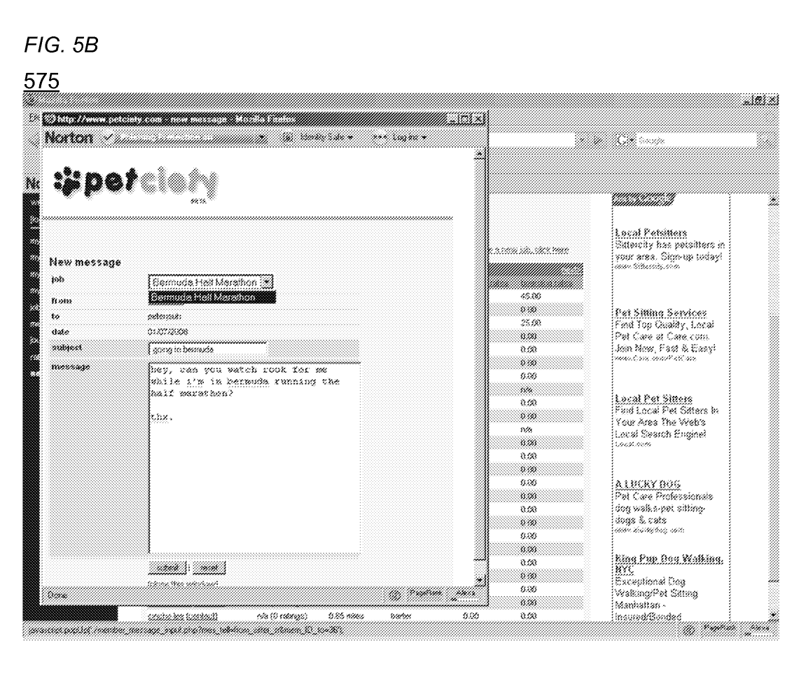

FIG. 5A shows a flowchart illustrating the system process for searching the Unilateral Barter Community at steps 505 and 510 for either a Service Provider or a Job associated with a Service Requestor in an embodiment of the invention. For both searches, the system may utilizes the same search criteria at step 515 and 540, such as: type of pet (dog, cat, bird, fish, other), level of service (professional, non-professional, barter), location (on-site or boarding), services (walking, feeding, playtime/indoor exercise, transportation), distance and number or records to display per page as referenced at step 575 or footnote #2 for FIG. 5A. In this embodiment, level of service may be a choice of 1 of 3 categories of members. Members can either be professionals which means they are professional pet sitters and carry all the proper licenses, insurance and bonding to be considered a professional pet sitter. A non-professional is a member who is not a professional sitter but would like to be compensated for sitting a pet. Members may also be barter which refers to the scenario where members choose to be part of the Unilateral Barter Community. In the case of location, On-site or Boarding may refer to the location in which the pet sitting would actually happen. The distance field is to aid in limiting the list of users the system may return. If the user selects a distance qualifier, the system may only bring back search results that are less that a specified number of miles away. Upon receiving the search criteria from a user, the system in steps 520 and 545, may analyze the search parameters and may return appropriate results within the specified parameters and may calculate and display the how far away users of the search results are from the user who initiated the search at steps 517 and 542. If the system does not find any search results that fit within the search criteria, the system may bring the user back to the search criteria page with an error message saying that no results could be found matching that criteria as in steps 525 and 550.

In the case where the user is searching for a Job associated with a Service Requestor at step 515, the system may allow Service Providers to message the Service Requestor at step 530. However, in the case where the user is searching for a Service Provider at step 540, the system at steps 555 and 560, preferably does not allow the Service Requestor to message another member unless a specific Job can be referenced. If the Service Requestor attempts to contact a member without a Job already in his queue, the system, at step 570, may return an error message informing the Service Requestor that messages without a Job are not permitted and may prompt the Service Requestor to create a new Job along with a shortcut link do to the job creation page. If the Service Requestor has one or more Jobs in the job queue, the system at step 565, may allow the message process to proceed and pre-populate a drop down box with all the jobs in the Service Requestor's queue.

FIG. 5B shows an exemplary screen shot of a message from a Service Requestor to a Service Provider in an embodiment of the invention. In this example, the user only has one job in his or her queue and therefore the system only displays one option in the drop down menu.

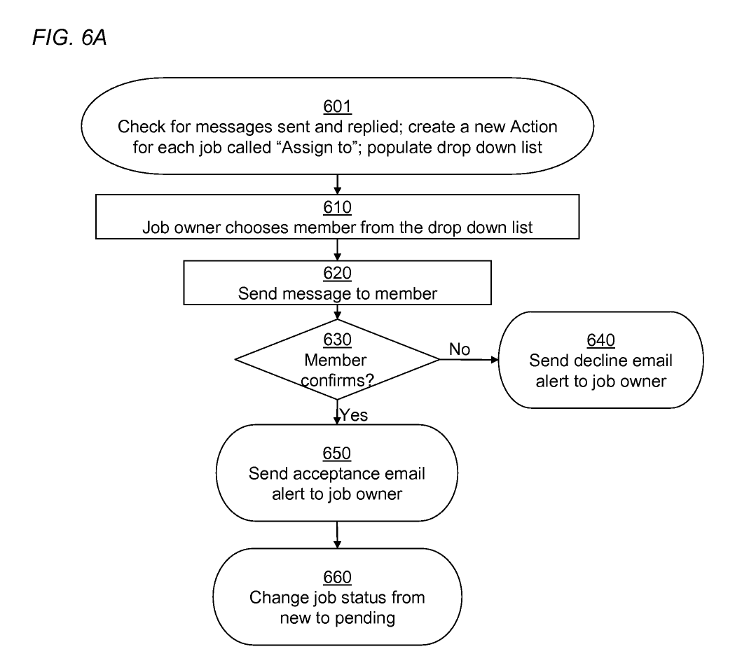

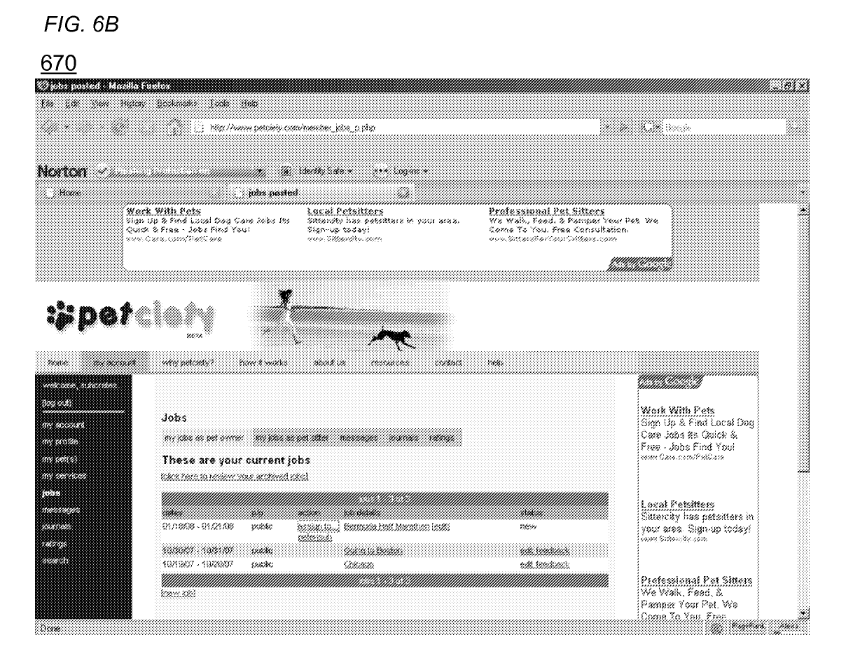

FIG. 6A describes the system process for assigning a Job to a Service Provider in an embodiment of the invention. At step 601, The system may only allow a Job to be assigned when there has been at least 1 message sent back and forth between the Service Requestor and a Service Provider with the referenced job code. Once a Service Provider replies to an initial message and creates a communication dialogue, the system may create a drop down list including the username of only the Service Providers with whom the job owner has had back and forth communications. In order to assign the job, the user clicks on the username underneath the Assign to drop down box at step 610. At step 620, the system may then generate an email alert informing the Service Provider that a Job assignment has been requested. The Service Provider can then accept or decline the Job assignment at step 630. Whichever option the Service Provider chooses the system may automatically generate an email informing the Service Requester that the Job was successfully assigned at step 650 or the Job was denied at step 640.

FIG. 6B shows an exemplary screen shot of a drop down box in an embodiment of the invention.

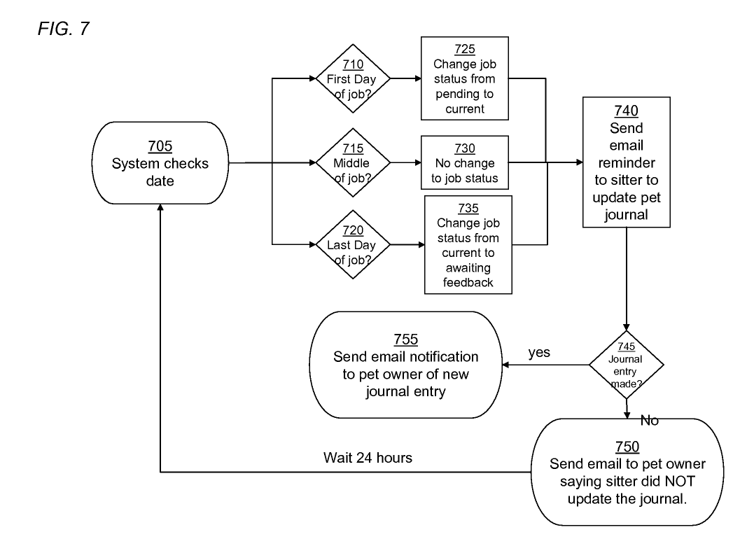

FIG. 7 illustrates the system flowchart for the Journal Tool in an embodiment of the invention. At step 705, the system preferably checks the current date and compares it to the start and end dates of all current jobs in steps 710, 715 and 720, and may then send an email reminder on a daily basis to all or some of the Service Providers of the current Jobs at step 740. Depending on the date, the system may change the job status as needed as in steps 725, 730 and 735 before sending the email reminder. The email reminder may have a link to take the Service Provider straight to the web form of the Journal Tool where the Service Provider submits a journal entry log for that day. Then, at step 755 the system may store the journal in the database and automatically generate an email to the Service Requestor informing him or her of the completed a journal entry. The email may also provide a link to where the system has displayed the journal entry. If the Service Provider does not complete the journal entry within preferably 2 days, the system at step 750, may still send an automatic email to the Service Requestor informing him or her that the Service Provider has not completed one of his or her duties.

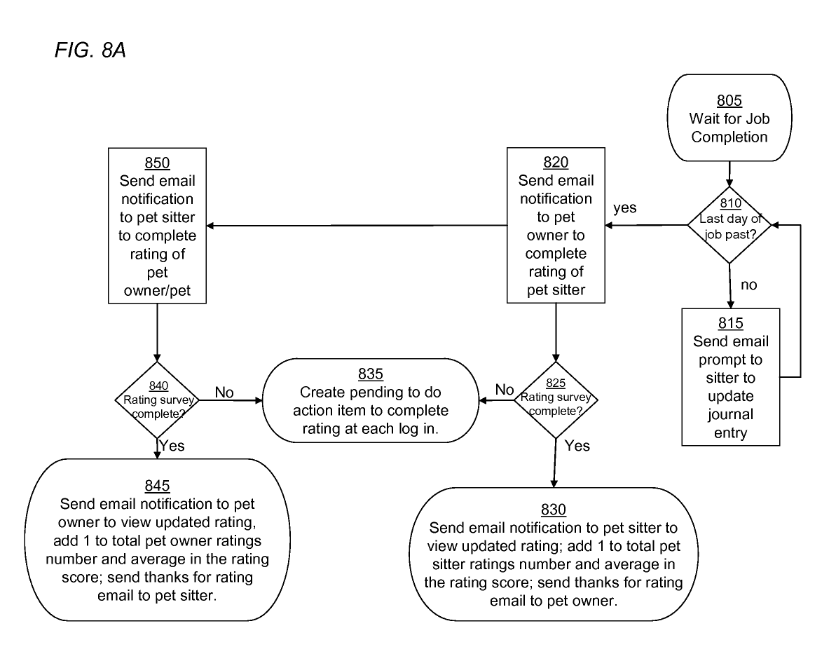

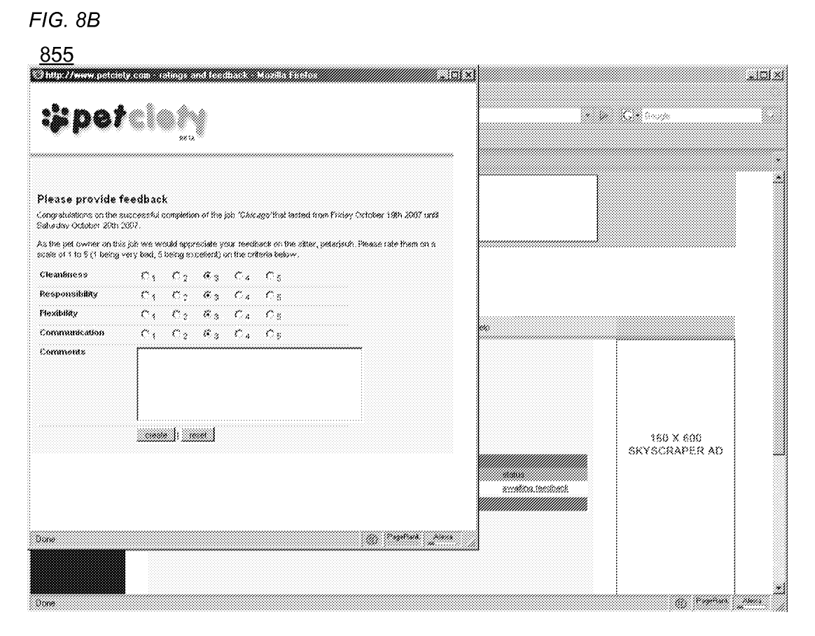

FIG. 8A illustrates the system flowchart for the Feedback Tool in an embodiment of the invention. Similar to step 705, the system may check the date against the dates of current jobs and waits for one day to pass before beginning the process for the Feedback Tool at steps 805, 810 and 815. One day after the last day of a Job, the system at steps 820 and 850, may send an automatic email alert to one or both of the Service Provider and Service Requestor. Once a user completes the feedback survey at steps 825 and 840, the system at steps 830 and 845 may create an email to the subject of the feedback survey informing him or her that a user has just left feedback regarding him or her. The email may also include a link to where the system has displayed the feedback. The system may also average the numerical score of the feedback based on preferably the four categories of rating and average in the total score with the user's previous score. Additionally, the system may add one to the total feedback counter and post and store any text commentary that the user may have written about the subject of survey. If the user does not complete the feedback survey, the system, in step 835 (also cross reference step 230) may update the user's welcome page.

FIG. 8B shows an exemplary screen shot of a web form the system generated for a Service Requestor to fill out feedback ratings regarding the services of the Service Provider for a job titled “Chicago” that started on Oct. 19, 2007 and lasted through Oct. 20, 2007.

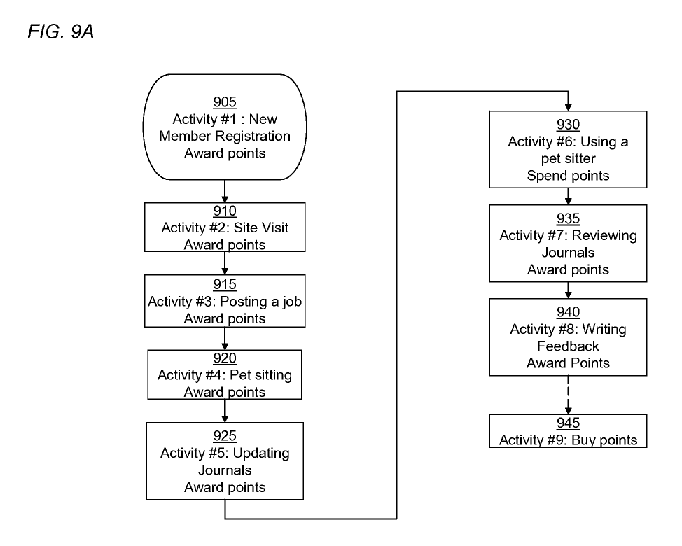

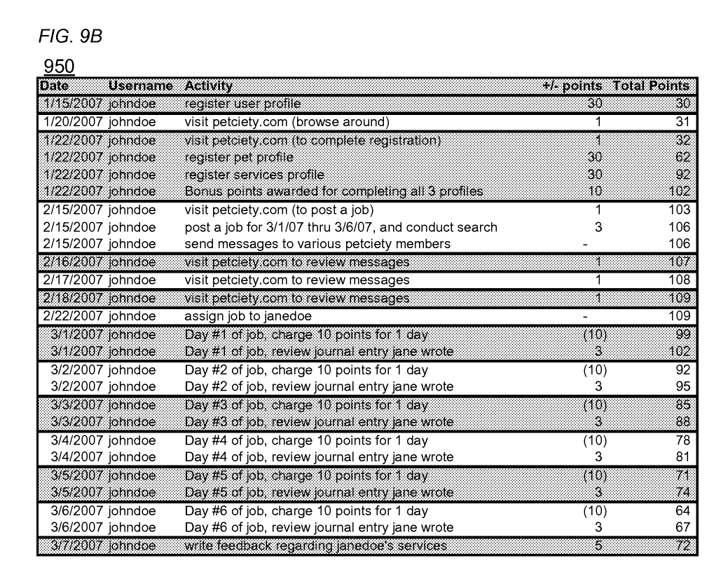

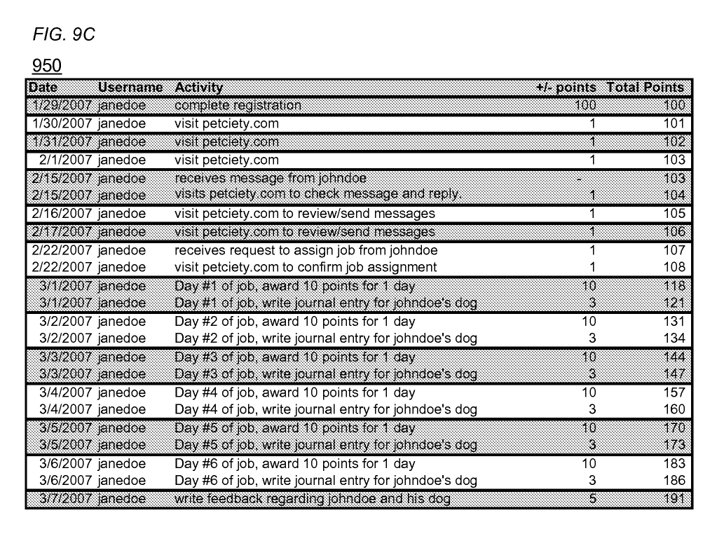

FIG. 9A illustrates another embodiment of the system, implementing a points program. A points program may allow users to more easily track the users' activities. This embodiment of the invention is similar to a rewards system, in which it awards points to members being Service Providers and for doing activities that are beneficial to the community. A points program helps police the social community and may prevent some users from taking advantage of the community as Service Requestors without providing a commensurate amount of services back as Service Providers.

As an example of the points system, point values for activities could be as follows:
The system in step 905, may award 30 points when a user completes the Basic User Profile, award an additional 30 points when the user completes step 2: pet details, award additional 30 points when the user completes step 3: service details. When a user completes all 3 steps, the system may then award 10 bonus points for completing the Enhanced User Profile.
The system in step 910, may award a user 1 point just for visiting the web site up to a maximum of one point per day.
The system in step 915, may award a user 3 points for posting a job as a Service Requestor. The more jobs posted under a Service Requestor user profile may build a travel profile for the user and allow the system to target ads better towards that user.
The system in step 920, may award 10 points per day for participating in the Unilateral Barter Community as Service Provider (barter, professional or non-professional).
The system in step 925, may award Service Providers an additional 5 points for each daily journal entry they fill in.
The system in step 930, may deduct 10 points per day for all users who participate as a Service Requestor in an assigned transaction.
The system in step 935, may award Service Requestors with 3 points for reviewing journal entries that Service Providers write.
The system in step 940, may award Service Requestors 5 points for writing feedback regarding the Service Provider upon the completion of a job.
The system in step 940, may award Service Providers 5 points for writing feedback regarding the Requestor upon the completion of a job.
If users run out of points and require additional points to complete a transaction, the system may allow the purchasing of points in step 945. For example, a user may be allowed to purchase points in fixed denominations, such as $5, $10, and $20. Conversions from dollar values to points may be based, for example, on some objective measure of the value of services rendered.

FIG. 9B and FIG. 9C illustrates some detailed examples broken down by dates and activities on how the point system could work for both a Service Provider and a Service Requestor in an embodiment of the invention.

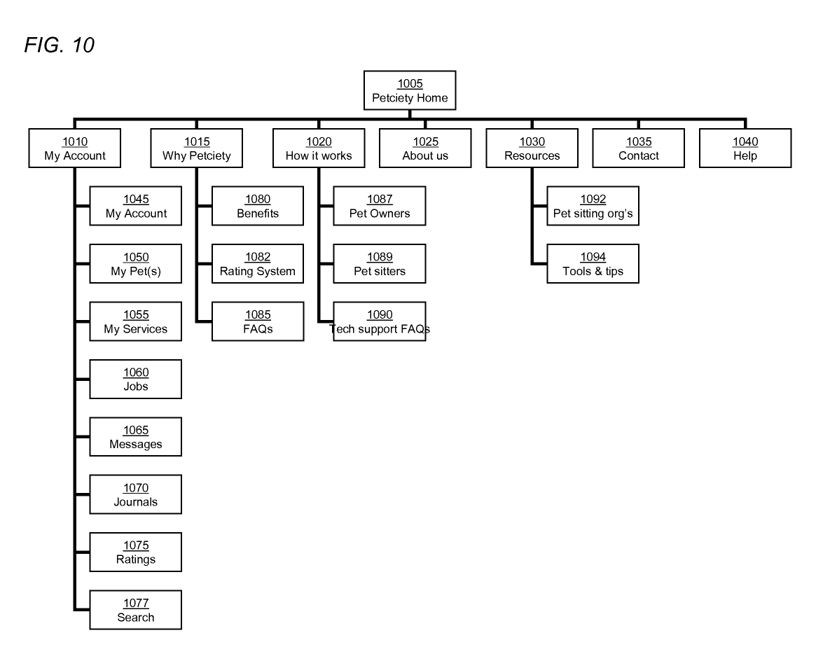

FIG. 10 illustrates the site architecture and navigation site map in a specific embodiment of the invention. It is understood that the following description is only illustrative and many alternative site architectures are possible, the architecture of an interactive web site being at least in part a matter of design choice.
Box 1005 is the site homepage and parent directory to which all pages may be accessible.
Box 1010 is the my account pages where all pages pertaining to a users account may be accessed.
   Box 1045 is the my account page where a user may access and edit all stored information regarding the users account and Basic Profile information
   Box 1050 is the my pet page where a user may access, edit and add all stored information regarding the user's pet or pets.
   Box 1055 is the my services page where a user may access and edit all stored information regarding the services he may be willing to provide.
   Box 1060 is the jobs page where a user may access all the stored information about prior jobs and create new jobs.
   Box 1065 is the messages page where the users may access all messages that have been sent through the system and create new messages, read new messages or reply to old messages.
   Box 1070 is the journal page where the users may access all stored journal entries pertaining to old or current jobs.
   Box 1075 is the ratings page where the user may have access to all ratings data stored about the user and may have access to all ratings the user may have written about other users.
   Box 1077 is the search page where users may search for other users or jobs.
Box 1015 is the Why Petciety page which may describe the reasons for why the site was created.
   Box 1080 is the Benefits pages which may describe the benefits of using the system and the site
   Box 1082 is the Rating System page which may describe how and why the ratings tools work
   Box 1085 is a compilation of all frequently asked questions
Box 1020 is the How it Works page which may describe the system processes and tools in more details
   Box 1087 is the Pet Owners page which may describe the system from the perspective of a Service Requestor
   Box 1089 is the Pet Sitters page which may describe the system from the perspective of a Service Provider
   Box 1090 is a compilation of a frequently asked questions of a technical nature.
Box 1025 is the About Us page which may provide more information about the site in general and the company that runs the site.
Box 1030 is the Resources page which may have links to other resources that may be helpful for the audience of the site.
   Box 1092 is a listing of some pet sitting organization and affiliations with links to more information about them.
   Box 1094 is a list of tools and tips that may be helpful to the users of the site.
Box 1035 is the Contact us page and may provide information on how to contact the company that operates the site.
Box 1040 is the help page which may be a way for users to contact the operators of the site in the event they did not find the answers to their questions anywhere else on the site.

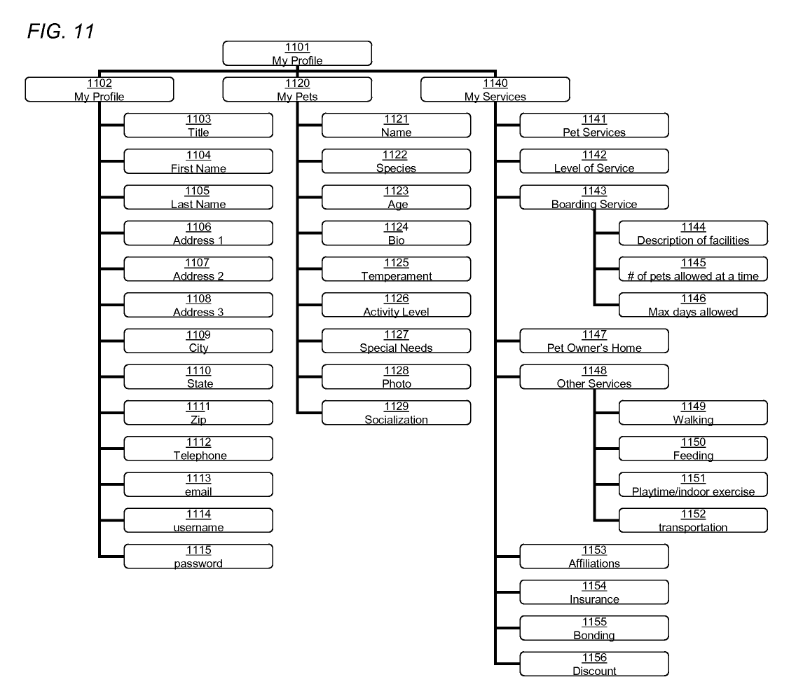

FIG. 11 illustrates a set of database fields within the my profile, box 1101, database for each individual user of the site in an embodiment of the invention. Box 1102 may represent the user's Basic User Profile and includes boxes 1003 through 1115 which may represent the subordinate database fields: title, first name, last name, address1, address2, address3, city, state, zip, telephone, email, username, and password. Box 1120 may represent the first part of the Enhanced User Profile and include details regarding a user pet. Boxes 1121 though 1129 may represent the subordinate database fields: name, species, age, bio, temperament, activity level, special needs, photo and socialization. Box 1140 may represent the second part of the Enhanced User Profile and includes details regarding a user's services. Boxes 1141 through 1156 may represent the subordinate database fields: pet services, level of service, boarding service, description of facilities, # of pets allowed at a time, max days allowed, pet owner's home, other services walking, feeding, playtime/indoor exercise, transportation, affiliations, insurance, bonding, and discount.

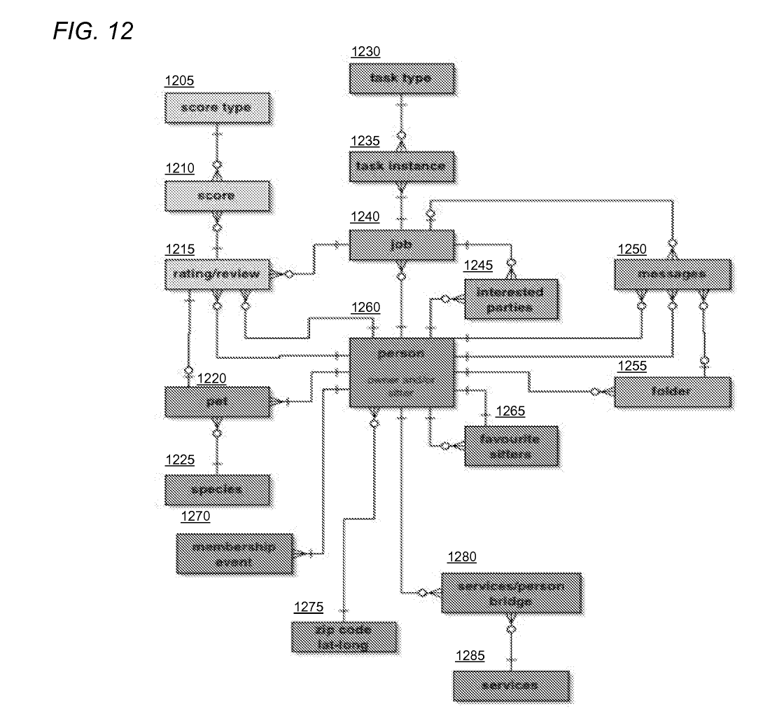

FIG. 12 illustrates a set of relational database entity flowchart and relationships between fields in an embodiment of the invention. Again, the specific design shown is only illustrative and not limiting. With box 1260 as the center of the diagram, the description will start at 12 o'clock and work clock wise around the box 1260 which represents a Person or the common user of the site and system. Box 1260 may have a one-to-many relationship with box 1240, meaning one user may have many jobs associated with the user. Each job may have a one-to-many relationship with Task instance, box 1235, and may be representative of any task specifically associated with a job such as journal entries or feedback ratings. Task instance may have a many-to-one relationship with task type box 1230 which would specify in the system exactly which type of task is being referenced. Person also may have a one-to-many relationship with interested parties, box 1245, which represents those users of the system who a Service Requestor may have messaged for a potential Service Provider and has responded to the initial message. In this embodiment, the Jobs, box 1240, would also have a one-to-many relationship with Interested parties, box 1245.

A Person may have a one-to-many relationship with Messages, box 1250 as does a Job. Messages can also be placed into Folders, box 1255, such as inbox, and sent and therefore may have a many-to-one relationship. A Person also may have a one-to-many relationship with Folders.

A Person may have a one-to-many relationship with Favorite sitters, box 1265, and the Person entity can also be a Favorite Sitter and therefore also may have a circular one-to-one relationship. A Person also may have a one-to-many relationship with Services/person bridge, box 1280 and Services/person bridge may have a many-to-one relationship with Services, box 1285. Simply put a Person may have many Jobs associated with the database entity and many or one Service Provider who performs the jobs, but for each job, there may only be one Service Provider. A person also may have a many-to-one relationship with zip code lat-long, box 1275, representing the many distances to other users one user may have in the system. A Person also may have a one-to-many relationship with Membership events, box 1270, which could be something as simple as a partial registration of the Basic User Profile or any of the two steps for the Enhanced User Profile.

A Person may have a one-to-many relationship with Pet, box 1220, simply because a user may have multiple pets concurrently or sequentially throughout the use of the system. Pet, box 1220 may have a one-to-one relationship with Species, box 1225.

A Person may have a one-to-many relationship with Rating/review, box 1215 because a user could have a rating for each Job that the system assigns. Jobs, box 1240 also may have a one-to-many relationship with Ratings/review because for each job completed, at least two ratings alerts are generated where both parties involved in the job may submit a review. Ratings/review may have a one-to-many relationship with Score, box 1210, because each rating may have multiple scores associated with it. Finally Score may have a many-to-one relationship with Score type, box 1205 because users can be rated in multiple roles for example as a Service Provider or a Service Requestor.

While the invention has been described in conjunction with specific embodiments, it will be appreciated that such embodiments are not limiting. In particular, the embodiments have been illustrated with reference to specific user interfaces, algorithms and data structures, which may be in part a matter of design choice. Accordingly, numerous alternatives, modifications, and variations are possible within the scope of the appended claims.

I claim:

1. A system for connecting service providers with service requesters, the system comprising:
a database storing user profiles for a plurality of users, the users comprising service providers and service requestors;
a requesting tool receiving a service request from a service requester, the service request including service information;
a query tool receiving query options from the service requester, generating a list of service providers based on the query options, and sending the list of service providers to the service requester;
a selection tool receiving from the service requestor a selection message identifying at least one service provider;
a feedback tool receiving from the service requester a service requester feedback message relating to a service provided by the at least one service provider, and storing the service requestor feedback message in the user profile of the service provider.

2. The system of claim 1, wherein the query tool generates the list of service providers based on the service information.

3. The system of claim 1, wherein the feedback tool receives from the at least one service provider a service provider feedback message relating to the service provided by the at least one service provider, and stores the service provider feedback message in the user profile of the service requestor.

4. The system of claim 1, wherein a user profile includes a user's location and rating, and the query tool generates the list of service providers based on at least one of physical proximity, services requested, provider rating, and requester rating.

5. The system of claim 1, wherein the list of service providers comprises only service providers with which the service requester has directly communicated regarding the service request.

6. The system of claim 1, wherein the system limits communication between a service requestor and service providers based on whether a service request has been received from the service requester.

7. The system of claim 1, wherein the service requester does not provide any compensation and is not subject to any obligation in return for the service provided by the at least one service provider.

8. The system of claim 1, further comprising:
a promotional tool sending the service requester promotional information based on the service information.

9. The system of claim 1, wherein the service requestor is a pet owner, the at least one service provider is a pet sitter, and the service is pet sitting.

10. The system of claim 1, further comprising:
a journal tool receiving journal entries from the service provider regarding a service that the service provider is performing and sending the journal entries to the service requester.

11. The system of claim 1, further comprising:
a rating tool computing a user rating based on the service provider feedback message and the service requester feedback message.

12. A method for connecting service providers with service requesters, the method comprising:
receiving a service request from a service requester, the service request including service information;
receiving a service request from a service requestor, the service request including service information;
receiving query options from the service requester;
generating a list of service providers based on the query options;
sending the list of service providers to the service requester;
receiving from the service requester a selection message identifying at least one service provider;
receiving from the service requester a service requester feedback message relating to a service provided by the at least one service provider; and
storing data associating the service requestor feedback message with the service provider.

13. The method of claim 12, wherein the service requester does not provide any compensation and is not subject to any obligation in return for the service provided by the at least one service provider.

14. The method of claim 12, wherein the service requester is a pet owner, the at least one service provider is a pet sitter, and the service is pet sitting.

15. A method for providing and soliciting services in a computer-based social network, the social network including a plurality of users, the method comprising:
adding points to a user for services performed by said user for other users of the social network;
subtracting points from a user for services received by said user from other users of the social network; and
limiting a user's ability to receive services from other users of the social network unless said user's points exceed a threshold.

16. The method of claim 15, further comprising:
matching a user providing services to a user receiving services; and
adding points to, and subtracting points from, the user providing services and the user receiving services only after the users have been matched.

17. The method of claim 15, wherein a user receiving a service does not provide any compensation and is not subject to any obligation in return for that service.

18. The method of claim 15, further comprising sending promotional information to a user based on services requested by said user.

19. The method of claim 15, further comprising adding points to a user for one of:
accessing a website;
entering information into a database; and
requesting services from other users of the social network.

20. The method of claim 15, further comprising:
adding points to a user based on a money payment by said user.
